(19) United States
(12) Patent Application Publication
(10) Pub. No.: US 2026/0097365 A1
(43) Pub. Date: Apr. 9, 2026

(54) WATER PURIFIER

(71) Applicant: COWAY CO., LTD., Gongju-si (KR)

(72) Inventors: Sungkon CHO, Seoul (KR); Hyoung Min MOON, Seoul (KR); Woo Jin JOO, Seoul (KR)

(73) Assignee: COWAY CO., LTD., Gongju-si (KR)

(21) Appl. No.: 19/267,769

(22) Filed: Jul. 14, 2025

(30) Foreign Application Priority Data
Oct. 8, 2024 (KR) 10-2024-0136649

(51) Int. Cl. B01D 61/02; B01D 61/04; B01D 61/08; B01D 61/12; B01D 65/02; C02F 1/00; C02F 1/44

(52) U.S. Cl. CPC B01D 61/025; B01D 61/04; B01D 61/08; B01D 61/12; B01D 65/02; C02F 1/008; C02F 1/441; B01D 2311/04; B01D 2313/08; B01D 2313/18; B01D 2321/12; C02F 2201/005; C02F 2303/16

(57) ABSTRACT

Provided is a water purifier which prevents an increase in the total dissolved solids (TDS) concentration of fluid located in a purified water zone of a reverse osmosis (RO) filter. Specifically, the water purifier may include a reverse osmosis (RO) filter including a raw water zone into which raw water flows from an outside, a purified water zone for accommodating purified water generated by filtering at least a portion of the raw water located in the raw water zone, and a reverse osmosis membrane partitioning the raw water zone and the purified water zone; a pretreatment filter configured to pretreat the raw water flowing into the RO filter and having a hollow through which the pretreated raw water passes; a flow channel connected to the pretreatment filter and the RO filter and providing a passage on which the raw water and the purified water flow; an inner guide including a cylindrical inner guide partition wall inserted into the hollow of the pretreatment filter and a passage hole formed through the inner guide partition wall and communicating with the hollow; a plurality of valves connected to the pretreatment filter and the RO filter and selectively opened/closed to regulate flow of the raw water and the purified water; and a controller configured to control opening/closing of the plurality of valves based on a plurality of flow modes.

### TECHNICAL FIELD

The present disclosure relates to a water purifier.

### BACKGROUND ART

A water purifier is a general term for any device that can receive raw water, treat the raw water into a user's desired state, and then provide purified water to the user. The water purifier can filter the raw water using various types of filters and provide purified water to the user.

Such a water purifier includes a filter that can filter impurities in the raw water to provide purified water to the user. The filter may be a reverse osmosis (RO) filter that includes a raw water zone into which the raw water flows, a reverse osmosis membrane that filters the raw water located in the raw water zone, and a purified water zone into which the purified water filtered by the reverse osmosis membrane flows.

A large amount of impurities can be accumulated in the reverse osmosis filter during the process of filtering the raw water. In other words, the reverse osmosis filter has water with a high concentration of total dissolved solids (TDS), i.e., water containing unfiltered ions, in the raw water zone based on the reverse osmosis membrane, and water with a low concentration of TDS, i.e., filtered water with ions removed, in the purified water zone.

Meanwhile, while water is not filtered through the reverse osmosis filter, water in the purified water zone of the reverse osmosis filter moves to the raw water zone by osmotic pressure. Thus, the TDS concentration of water in the purified water zone of the reverse osmosis filter increases and becomes similar to the TDS concentration of water in the raw water zone.

In this state, when filtration is resumed through the reverse osmosis filter, there is a problem in that water with a high concentration of TDS in the purified water zone of the reverse osmosis filter is supplied to the user at an initial stage, and this phenomenon is called a creep phenomenon.

In a water purifier according to the related art, in order to reduce the creep phenomenon, a method of minimizing the volume of the raw water zone, removing water in the raw water zone, or flushing the raw water zone is used.

In the case of the method of flushing the raw water zone, for example, a technology in which a tank for storing a certain amount of the purified water is separately provided and the purified water stored in the tank is provided to the raw water zone of a reverse osmosis filter (Korean Patent Registration No. 10-0480984), has been used, however, there is a problem in that, because a separate tank for storing the purified water for flushing needs to be provided, the volume of the water purifier has to be large.

In addition, Korean Patent Registration No. 10-2622548 discloses a technology for performing flushing by supplying the purified water generated in a reverse osmosis filter to a raw water zone of the reverse osmosis filter through a separate flushing line. However, in this method, there is a disadvantage in that the method can only cause continuous concentration of a reverse osmosis membrane and when the purified water used for flushing the reverse osmosis filter is discharged externally, the raw water additionally needs to flow in, which can only cause continuous concentration of the reverse osmosis membrane.

### PRIOR-ART DOCUMENT

### Patent Document

Korean Patent Registration No. 10-0480984 (published on Mar. 24, 2005)

Korean Patent Registration No. 10-2622548 (published on Jan. 4, 2024)

### DISCLOSURE

### Technical Problem

According to the present invention, the present disclosure provides a water purifier in which, because the purified water may be circulated between a reverse osmosis (RO) filter and a pretreatment filter in a purified water circulation mode, a total dissolved solids (TDS) concentration of the inside of the RO filter, in particular, a purified water zone can be prevented from being increased. In other words, the present disclosure provides a water purifier in which, because the purified water may be circulated to flow into a purified water zone from a raw water zone in the purified water circulation mode, the TDS concentration of water in the purified water zone can be prevented from being increased.

In addition, the present disclosure also provides a water purifier in which, because an inner guide is applied to the pretreatment filter to achieve the first-in, first-out effect, when the water purification circulation mode is performed, a certain amount of the purified water with a low TDS concentration can be stored in the pretreatment filter, so that the flushing effect in a flushing mode to be performed later is maximized and even when a separate water purification tank for performing flushing is not provided, flushing can be performed, enabling product miniaturization.

In addition, the present disclosure also provides a water purifier in which, because the purified water is not discharged externally in the purified water circulation mode, the TDS concentration of the purified water located in the purified water zone of the RO filter can be prevented from being increased and water can be prevented from being wasted.

In addition, the present disclosure also provides a water purifier in which the purified water circulation mode is performed for a certain amount of time before a purified water discharge mode so that the purified water can be circulated between the RO filter and the pretreatment filter a plurality of times and thus the purified water having a low TDS concentration in the purified water discharge mode can be provided to a user.

In addition, the present disclosure also provides a water purifier in which, in a raw water flushing mode and in a purified water flushing mode, a reverse osmosis membrane can be cleaned and the water for daily use located in the raw water zone can be discharged externally so that the TDS concentration of the RO filter can be lowered.

In addition, the present disclosure also provides a water purifier in which, because the RO filter can be cleaned with the purified water accommodated in the pretreatment filter in the purified water flushing mode, the TDS concentration of a fluid located in the raw water zone of the RO filter can be lowered.

In addition, the present disclosure also provides a water purifier in which a daily use water discharge flow path can be selectively opened or closed depending on whether the amount of purified water continuously discharged through a discharge port in the purified water discharge mode is greater than a reference discharge amount or not, so that the overconcentration of the RO filter can be prevented.

### Technical Solution

According to an aspect of the present disclosure, there is provided a water purifier including: a reverse osmosis (RO) filter including a raw water zone into which raw water flows from an outside, a purified water zone for accommodating purified water generated by filtering at least a portion of the raw water located in the raw water zone, and a reverse osmosis membrane partitioning the raw water zone and the purified water zone; a pretreatment filter configured to pretreat the raw water flowing into the RO filter

and having a hollow through which the pretreated raw water passes; a flow channel connected to the pretreatment filter and the RO filter and providing a passage on which the raw water and the purified water flow; an inner guide including a cylindrical inner guide partition wall inserted into the hollow of the pretreatment filter and a passage hole formed through the inner guide partition wall and communicating with the hollow; a plurality of valves connected to the pretreatment filter and the RO filter and selectively opened/closed to regulate flow of the raw water and the purified water; and a controller configured to control opening/closing of the plurality of valves based on a plurality of flow modes.

The inner guide partition wall may be arranged to cut off communication between a filtering unit of the pretreatment filter and the hollow, and may have a passage flow path aligned with the hollow formed therein, and the passage hole may communicate with the passage flow path, and a fluid may flow into the inner guide through the passage hole.

The passage hole may be arranged closer to a second end facing the first end where a pretreatment inlet and a pretreatment outlet of the pretreatment filter are formed.

The fluid remaining in the pretreatment filter may be discharged through the pretreatment outlet before the purified water flowing into the pretreatment filter.

The plurality of flow modes may include a purified water circulation mode in which the purified water circulates between the pretreatment filter and the RO filter, and the controller may control opening/closing of the plurality of valves so that, when in the purified water circulation mode, the purified water discharged from the purified water zone flows into the pretreatment filter and the purified water that has passed through the pretreatment filter flows into the raw water zone.

The flow channel may include a purified water circulation flow path connecting between the purified water zone and the pretreatment filter, and the plurality of valves may further include a purified water circulation valve arranged on the purified water circulation flow path and configured to open/close the purified water circulation flow path, and the controller may control the purified water circulation valve so that, when in the purified water circulation mode, the purified water circulation flow path is opened.

The flow channel may include: a RO filter inflow flow path connecting between a pretreatment outlet of the pretreatment filter and a raw water zone of the RO filter; and a return flow path connecting between the raw water zone and the RO filter inflow flow path.

The controller may control opening/closing of the plurality of valves so that, when in the purified water circulation mode, the daily use water discharged from the raw water zone flows into the raw water zone through the return flow path and the RO filter inflow flow path.

The plurality of flow modes may further include a purified water discharge mode in which the purified water located in the purified water zone is discharged externally, and the controller may control opening/closing of the plurality of valves so that, when in the purified water discharge mode, the purified water located in the purified water zone is discharged externally.

The controller may control opening/closing of the plurality of valves according to the purified water circulation mode for a predetermined amount of time before the purified water discharge mode.

The flow channel may include a purified water discharge flow path connecting between the purified water zone and a discharge port, and the plurality of valves may include a purified water discharge valve arranged on the purified water discharge flow path and configured to open/close the purified water discharge flow path, and the controller may control opening/closing of the plurality of valves so that, when in the purified water circulation mode, the purified water discharge flow path is closed and when in the purified water discharge mode, the purified water discharge flow path is opened.

The plurality of flow modes may further include a purified water flushing mode in which the reverse osmosis membrane is cleaned with the purified water accommodated in the pretreatment filter, and the controller may control opening/closing of the plurality of valves so that, when in the purified water flushing mode, the purified water accommodated in the pretreatment filter flows into the raw water zone and the water for daily use in the raw water zone is discharged externally.

The flow channel may further include a daily use water discharge flow path on which the water for daily use in the raw water zone is discharged externally, and the plurality of valves may further include a daily use water discharge valve arranged on the daily use water discharge flow path and configured to open/close the daily use water discharge flow path, and the controller may control opening/closing of the daily use water discharge valve so that the daily use water discharge flow path is closed in the purified water circulation mode and the purified water discharge mode and the daily use water discharge flow path is opened in the purified water flushing mode.

The controller may control opening/closing of the plurality of valves so that, in the purified water discharge mode, when an amount of the purified water located in the purified water zone and discharged externally through the discharge port is less than a reference discharge amount, the purified water discharge valve is opened and the daily use water discharge valve is closed, and when the amount of the purified water located in the purified water zone and discharged externally through the discharge port is greater than the reference discharge amount, the purified water discharge valve is opened and the daily use water discharge valve is opened.

The controller may control opening/closing of the plurality of valves so that, in the purified water discharge mode, when an amount of the purified water discharged externally through the discharge port is greater than a reference discharge amount, an opening degree of the purified water discharge valve is greater than an opening degree of the daily use water discharge valve.

The size of a hole when the purified water discharge valve is opened, may be

greater than the size of a hole when the daily use water discharge valve is opened.

The daily use water discharge flow path may include: a first daily use water discharge flow path; and a second daily use water discharge flow path arranged in parallel to the first daily use water discharge flow path, and the daily use water discharge valve may include: a first daily use water discharge valve arranged on the first daily use water discharge flow path; and a second daily use water discharge valve arranged on the second daily use water discharge flow path.

The size of a hole when the first daily use water discharge valve is opened, may be greater than the size of a hole when the second daily use water discharge valve is opened, and the control may control opening/closing of the plurality of valves so that, in the purified water discharge mode, when an amount of the purified water discharged externally through the discharge port is greater than the reference discharge amount, the first daily use water discharge valve is closed, and the second daily use water discharge valve is opened.

The controller may control opening/closing of the plurality of valves so that, in the purified water flushing mode, the first daily use water discharge valve is opened and the second daily use water discharge valve is closed.

The water purifier may further include a third daily use water discharge valve, which is arranged on the first daily use water discharge flow path to be located at a downstream of the first daily use water discharge valve and of which opening degree is capable of being regulated by the controller, and the controller may control opening/closing of the plurality of valves so that, in the purified water discharge mode, when an amount of the purified water discharged externally through the discharge port is greater than a reference discharge amount, the first daily use water discharge valve is opened, and the second daily use water discharge valve is closed, and the opening degree of the third daily use water discharge valve is less than the opening degree of the purified water discharge valve.

### Advantageous Effects

In a water purifier according to the present invention, because the purified water can be circulated between a reverse osmosis (RO) filter and a pretreatment filter in a purified water circulation mode, a total dissolved solids (TDS) concentration of an inside of the RO filter, in particular, a purified water zone can be prevented from being increased. In other words, because the purified water can be circulated inside the water purifier to flow into the purified water zone from a raw water zone in the purified water circulation mode, the concentration of the purified water zone can be prevented from being increased.

In addition, because an inner guide is applied to the pretreatment filter to achieve the first-in, first-out effect, when the water purification circulation mode is performed, a certain amount of the purified water with a low TDS concentration can be stored in the pretreatment filter, so that the flushing effect in a flushing mode to be performed later is maximized and even when a separate water purification tank for performing flushing is not provided, flushing can be performed so that the miniaturization of a product is possible.

In addition, because the purified water is not discharged externally in the purified water circulation mode, the TDS concentration of the purified water located in the purified water zone of the RO filter can be prevented from being increased and water can be prevented from being wasted.

In addition, the purified water circulation mode is performed for a certain amount of time before a purified water discharge mode so that the purified water can be circulated between the RO filter and the pretreatment filter a plurality of times and thus, the purified water having a low TDS concentration in the purified water discharge mode can be provided to a user.

In addition, when in a raw water flushing mode and in a purified water flushing mode, a reverse osmosis membrane can be cleaned and the water for daily use located in the raw water zone can be discharged externally so that the TDS concentration of the RO filter can be lowered.

In addition, the RO filter can be cleaned with the purified water accommodated in the pretreatment filter in the purified water flushing mode so that the TDS concentration of a fluid located in the raw water zone of the RO filter can be lowered.

In addition, a daily use water discharge flow path can be selectively opened or closed depending on whether the amount of the purified wafer continuously discharged through a discharge port in the purified water discharge mode is greater than a reference discharge amount or not, so that the overconcentration of the RO filter can be prevented.

### BRIEF DESCRIPTION OF DRAWINGS

FIG. 1 is a view illustrating a water purifier according to an embodiment of the present disclosure;

FIG. 2 is a view illustrating a pretreatment filter of the water purifier of FIG. 1;

FIG. 3 is a cross-sectional view for explaining a filter according to the related art in which no inner guide is installed;

FIG. 4 is a cross-sectional view for explaining a pretreatment filter in which an inner guide is installed, according to an embodiment of the present disclosure;

FIG. 5 is a view illustrating the flow of a fluid when the water purifier of FIG. 1 operates in a purified water circulation mode;

FIG. 6 is a view illustrating the flow of the fluid when the water purifier of FIG. 1 operates in a purified water discharge mode, which illustrates the flow of the fluid when the amount of the purified water continuously discharged through a discharge port is less than a reference discharge amount;

FIG. 7 is a view illustrating the flow of the fluid when the water purifier of FIG. 1 operates in the purified water discharge mode, which illustrates the flow of a fluid when the amount of the purified water continuously discharged through the discharge port is greater than the reference discharge amount;

FIG. 8 is a view illustrating the flow of the fluid when the water purifier of FIG. 1 operates in a flushing mode;

FIG. 9 is a view illustrating a water purifier according to another embodiment of the present disclosure; and

FIG. 10 is a view illustrating a water purifier according to another embodiment of the present disclosure.

### DETAILED DESCRIPTION OF PREFERRED EMBODIMENTS

In some cases, in order to avoid ambiguity in the concept of the present disclosure, known structures and devices may be omitted or illustrated in block diagram form focusing on the core functions of each structure and device.

Through the specification, when a part is said to “comprising” or “including” a certain component, this does not mean excluding other components unless specifically stated otherwise, but rather that other components may be included. In addition, terms such as “part,” “unit,” and “module” described in the specification mean a unit that processes at least one function or operation, which may be implemented by hardware or software or a combination of hardware and software. In addition, “a (or an),” “one,” “the,” and similar related words may be used in the context of describing the present disclosure (specifically in the context of the claims below) to include both singular and plural meanings, unless otherwise indicated in the specification or clearly contradicted by the context.

In describing embodiments of the present disclosure, when it is determined that detailed descriptions of known functions or configurations may unnecessarily obscure the gist of the present disclosure unnecessarily, the detailed descriptions will be omitted. In addition, the terms described below are terms defined in consideration of functions in the embodiments of the present disclosure, and these may vary depending on the intention or custom of a user or operator. Thus, the definitions should be made based on the contents throughout the present specification.

Hereinafter, the present disclosure will be described in detail with reference to the accompanying drawings.

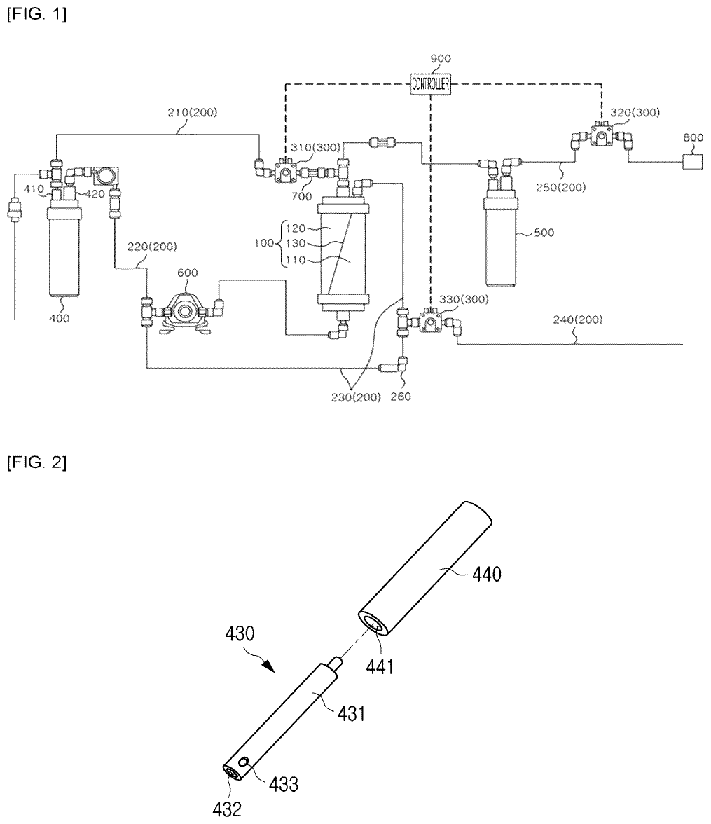

Referring to FIG. 1, a water purifier 1 according to an embodiment of the present disclosure may provide the purified water generated by filtering water flowing in from the outside, to a user. The water purifier 1 may include a reverse osmosis (RO) filter 100, a flow channel 200, a valve unit 300 including a plurality of valves, a pretreatment filter 400, a posttreatment filter 500, a pump 600, a circulation check valve 700, a discharge port 800, and a controller 900.

The RO filter 100 may filter the incoming raw water and provide the raw water as the purified water. When the RO filter 100 is configured to filter a portion of the introduced raw water, the RO filter 100 may provide other portion of the raw water that is not filtered as the water for daily use. For example, the RO filter 100 may be a reverse osmosis filter. The raw water in the present specification may refer to water before being filtered by the RO filter 100 regardless of the pretreatment filter 400, and the purified water may refer to water filtered by the RO filter 100 regardless of filtering in the posttreatment filter 500. In addition, the water for daily use may refer to water that is not filtered by the RO filter 100. The RO filter 100 may include a raw water zone 110, a purified water zone 120, and a reverse osmosis membrane 130.

The raw water may flow into the raw water zone 110. The raw water zone 110 may be partitioned by the reverse osmosis membrane 130, and the water for daily use including dissolved solids may flow into the raw water zone 110. A return flow path 230 may communicate with the raw water zone 110, and the water for daily use located in the raw water zone 110 may be discharged externally of the RO filter 100 through the return flow path 230.

The purified water filtered by the reverse osmosis membrane 130 may flow into the purified water zone 120. The purified water zone 120 may be partitioned by the reverse osmosis membrane 130 and may communicate with one of a circulation flow path 210 and a purified water discharge flow path 250. Thus, the purified water located in the purified water zone 120 may be discharged to the outside of the RO filter 100 through one or more of the circulation flow path 210 and the purified water discharge flow path 250.

The reverse osmosis membrane 130 is arranged to cross the internal space of the RO filter 100, and the raw water zone 110 and the purified water zone 120 may be partitioned by the reverse osmosis membrane 130. The reverse osmosis membrane 130 may be configured to filter the raw water located in the raw water zone 110, and a portion of the unfiltered raw water may be formed as the water for daily use.

The flow channel 200 may be connected to the pretreatment filter 400, the RO filter 100, the posttreatment filter 500, and the discharge port 800 and may provide a passage through which the raw water, the purified water and the water for daily use are flowing. The flow channel 200 may include the circulation flow path 210, an RO filter inflow flow path 220, the return flow path 230, a daily use water discharge flow path 240, and a purified water discharge flow path 250.

The circulation flow path 210 may be connected to the purified water zone 120 and the pretreatment filter 400 and may provide a passage through which the purified water located in the purified water zone 120 flows into the pretreatment filer 400.

The RO filter inflow flow path 220 may provide a passage through which water flows into the RO filter 100. Water inflowing through the RO filter inflow flow path 220 may be the raw water, the purified water or water for daily use. The RO filter inflow flow path 220 may communicate with the raw water zone 110 of the RO filter 100.

The return flow path 230 may provide a passage through which the water for daily use flows. The return flow path 230 may be connected to the raw water zone 110 and the RO filter inflow flow path 220 so that the water for daily use may flow into the raw water zone 110 through the return flow path 230 and the RO filter inflow flow path 220.

The daily use water discharge flow path 240 may provide a passage through which the water for daily use flows so that the water for daily use may be discharged externally. The daily use water discharge flow path 240 may be connected to the return flow path 230 so that the water for daily use discharged from the return flow path 230 may be discharged externally.

The purified water discharge flow path 250 may provide a passage through which the purified water flows, so as to discharge the purified water externally. The purified water discharge flow path 250 may be connected to the purified water zone 120 and the discharge port 800 so that the purified water located in the purified water zone 120 may be discharged externally through the discharge port 800.

A resistance valve 260 may be installed on the return flow path 230, and more specifically, may be installed at a downstream than a portion connected to the daily use water discharge valve 330. A fluid flow resistance on a flow path in which the resistance valve 260 is installed, is increased compared to a flow path in which the resistance valve 260 is not installed, and in other words, when the daily use water discharge valve 330 is opened, the fluid located in the raw water zone 110 may be naturally discharged along the daily use water discharge flow path 240 having a fluid flow resistance less than the return flow path 230 having a large fluid flow resistance. When the daily use water discharge valve 330 is closed, the fluid located in the raw water zone 110 may flow into the raw water zone 110 along the return flow path 230 and the RO filter inflow flow path 220.

The valve unit 300 may include a plurality of valves that are selectively opened/closed to regulate the flow of the raw water, the purified water and water for daily use of the flow channel 200. The valve unit 300 may include a circulation valve 310, a purified water discharge valve 320, and a daily use water discharge valve 330.

The circulation valve 310 may be installed on the circulation flow path 210 and may open/close the circulation flow path 210. When the circulation valve 310 opens the circulation flow path 210, the purified water located in the purified water zone 120 may flow into the pretreatment filter 400 through the circulation flow path 210.

The purified water discharge valve 320 may be installed on the purified water discharge flow path 250 and may open/close the purified water discharge flow path 250. When the purified water discharge valve 320 opens the purified water discharge flow path 250, the purified water located in the purified water zone 120 may be discharged externally through the purified water discharge flow path 250 and the discharge port 800.

The daily use water discharge valve 330 may be installed on the daily use water discharge flow path 240 and may open/close the daily use water discharge flow path 240. When the daily use water discharge valve 330 opens the daily use water discharge flow path 240, the water for daily use located in the raw water zone 110 may be discharged externally through the daily use water discharge flow path 240. In addition, when the daily use water discharge valve 330 closes the daily use water discharge flow path 240, the water for daily use located in the raw water zone 110 may flow into the raw water zone 110 through the return flow path 230.

The pretreatment filter 400 is configured to pretreat the raw water flowing into the RO filter 100 before flowing into the RO filter 100. The purified water located in the purified water zone 120 may flow into the pretreatment filter 400. The pretreatment filter 400 may be installed on the RO filter inflow flow path 220, and the purified water may circulate between the pretreatment filter 400 and the RO filter 100 through the RO filter inflow flow path 220 and the circulation flow path 210.

A pretreatment inlet 410 through which the raw water or the purified water flows in, and a pretreatment outlet 420 through which the filtered raw water or purified water is discharged, may be formed in the pretreatment filter 400. The pretreatment inlet 410 may communicate with the circulation flow path 210 and the RO filter inflow flow path 220, and the purified water on the circulation flow path 210 and the raw water on the RO filter inflow flow path 220 may flow into the pretreatment inlet 410, may be filtered and then, may be discharged from the pretreatment outlet 420 and may flow into the RO filter 100.

Meanwhile, an inner guide 430 may be installed in the pretreatment filter 400 according to an embodiment of the present disclosure.

Referring to FIG. 2, the filtering unit 440 that filters the raw water flowing in from the outside may be provided in a cylindrical shape having a hollow 441 therein.

The inner guide 430 may include an inner guide partition wall 431, a passage flow path 432, and a passage hole 433.

The inner guide 430 may be inserted into the hollow 441 of the filtering unit 440. The inner guide partition wall 431 may be provided in a cylindrical shape having the passage flow path 432 therein, as with the filtering unit 440, and the diameter of the inner guide partition wall 431 may be at least equal to or greater than the inner diameter of the hollow 441. Thus, when the inner guide 430 is inserted into the hollow 441 of the filtering unit 440, the inner guide partition wall 431 may be arranged to cut off communication between a filtration zone 440a of the filtering unit 440 and the hollow 441.

The passage flow path 432 may be aligned to be coaxially disposed with the hollow 441, and the passage hole 433 may be formed to pass through one side of the inner guide partition wall 431. Thus, the raw water or purified water that has passed through the filtration zone 440a may flow into the passage flow path 432 only through the passage hole 433, and further, may be discharged to the outside of the pretreatment filter 400 through the pretreatment outlet 420. To this end, the pretreatment inlet 410 may be formed in a radially outward direction based on the filtering unit 440, and the pretreatment outlet 420 may be formed in a radially inward direction based on the filtering unit 440.

Meanwhile, the passage hole 433 may be formed at a position closer to a second end 400b facing a first end 400a in which the pretreatment inlet 410 and the pretreatment outlet 420 of the pretreatment filter 400 are formed. Thus, it is possible to use the pretreatment filter 400 as a kind of water purification tank. Detailed descriptions thereof will be provided below.

The posttreatment filter 500 may filter the purified water generated by the RO filter 100 again. The posttreatment filter 500 may be installed on the purified water discharge flow path 250 so that purified water filtered by the posttreatment filter 500 may flow into the discharge port 800 through the purified water discharge flow path 250. The pump 600 may pressurize the raw water or purified water flowing within the RO filter inflow flow path 220. The pump 600 may be installed on the RO filter inflow flow path 220 so that the purified water or raw water may flow into the RO filter 100 by using the pump 600.

The circulation check valve 700 may be installed on the circulation flow path 210, thereby preventing backflow of the purified water into the purified water zone 120. The circulation check valve 700 may be positioned between the circulation valve 310 and the RO filter 100.

The discharge port 800 may be configured to discharge the purified water to the user and may be installed on the purified water discharge flow path 250.

The controller 900 may control opening/closing of a plurality of valves based on a plurality of flow modes. Here, the plurality of flow modes may include a purified water circulation mode, a purified water discharge mode, a raw water flushing mode, and a purified water flushing mode.

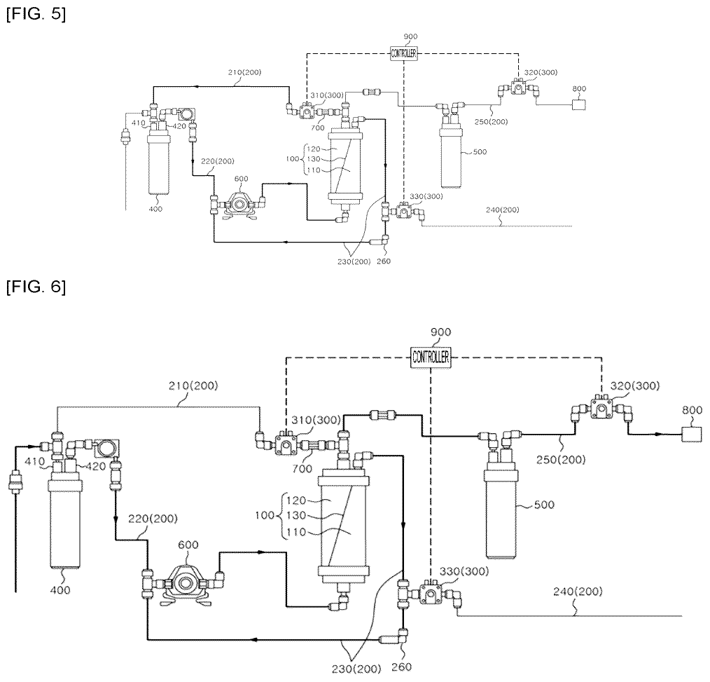

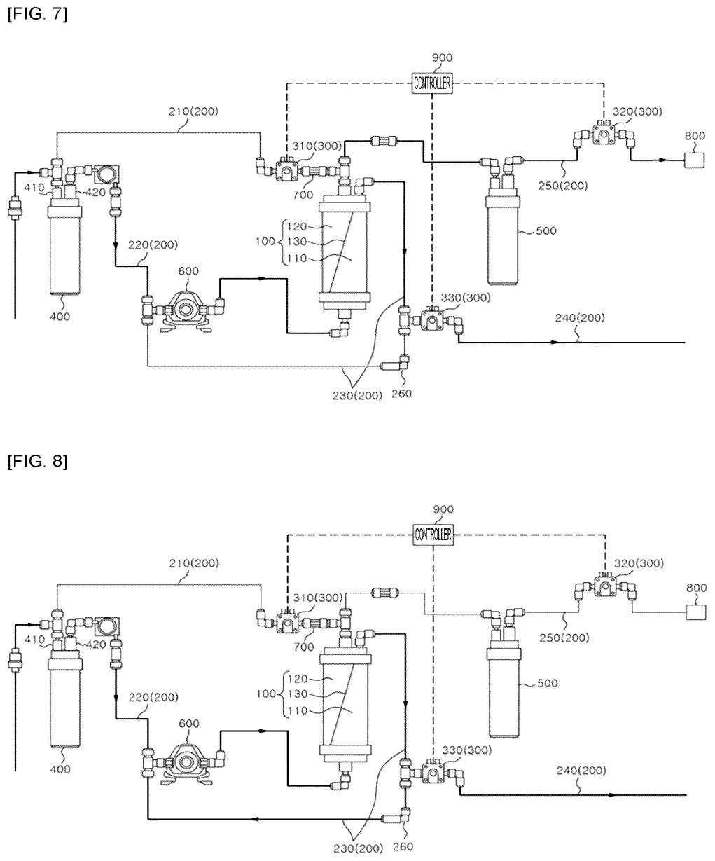

Referring to FIG. 5, the purified water circulation mode is a mode in which the purified water circulates between the pretreatment filter 400 and the RO filter 100. The purified water circulation mode may be performed before and after the purified water discharge mode.

The controller 900 may control opening/closing of the plurality of valves so that, when in the purified water circulation mode, the purified water located in the purified water zone 120 flows into the pretreatment filter 400 and the purified water discharged from the pretreatment filter 400 flows into the raw water zone 110. Specifically, the controller 900 may control the circulation valve 310 so that, when in the purified water circulation mode, the circulation flow path 210 may be opened, and the controller 900 may control the purified water discharge valve 320 so that the purified water discharge flow path 250 may be closed, and the controller 900 may control the daily use water discharge valve 330 so that the daily use water discharge flow path 240 may be closed. Through the above-described control, the purified water located in the purified water zone 120 may flow into the pretreatment filter 400 through the circulation flow path 210, may be discharged from the pretreatment filter 400 and may flow into the raw water zone 110 of the RO filter 100 through the RO filter inflow flow path 220. That is, in the purified water circulation mode, the purified water may circulate inside the water purifier 1 so as to flow from the raw water zone 110 into the purified water zone 120.

Meanwhile, the water for daily use located in the raw water zone 110 may flow into the raw water zone 110 through the return flow path 230 and the RO filter inflow flow path 220 when in the purified water circulation mode. Thus, the amount of water discharged from the RO filter 100 and the amount of water reflowing into the RO filter 100 may be maintained so that purified water circulation may be performed without additional supply of the raw water.

The controller 900 may control the plurality of valves so that the purified water circulation mode may be performed for a predetermined amount of time. Thus, in the purified water circulation mode, the purified water may circulate between the pretreatment filter 400 and the RO filter 100 a plurality of times for the predetermined amount of time.

When the purified water circulation mode is performed after the purified water discharge mode, the purified water may be accommodated in the pretreatment filter 400.

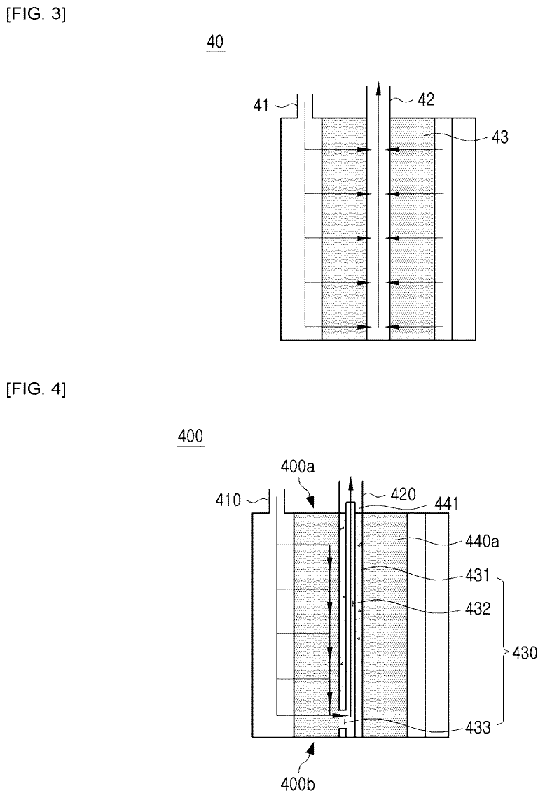

In a general pretreatment filter 400, as shown in FIG. 3, the raw water or purified water flowing into the pretreatment inlet 410 may be discharged externally through the pretreatment outlet 420 while passing through the upper portion of the filtration zone 440a, however, the raw water or purified water may also be discharged externally through the pretreatment outlet 420 while passing through the lower portion of the filtration zone 440a. In other words, this means that raw water or purified water that is first introduced through the pretreatment inlet 410 is not necessarily discharged externally through the pretreatment outlet 420 before the raw water or purified water that is introduced later. That is, when the raw water or purified water that is first introduced is directed toward the lower portion of the filtration zone 440a and the raw water or purified water that is introduced later is directed toward the upper portion of the filtration zone 440a, the raw water or purified water that is introduced later may be discharged first through the pretreatment outlet 420. In other words, in the case of the general pretreatment filter 400, so-called first-in, first-out cannot be properly achieved.

However, in the case of the pretreatment filter 400 according to an embodiment of the present disclosure, the fluid passing through the filtration zone 440a due to the inner guide 430 may only be directed toward the pretreatment outlet 420 through the passage hole 433. Because the passage hole 433 is located close to the second end facing the first end in which the pretreatment outlet 420 is formed, even when the raw water or purified water flows into the upper portion of the filtration zone 440a through the pretreatment inlet 410, the raw water or purified water has to flow again in a direction of the second end toward the passage hole 433 so that the raw water or purified water may be discharged through the pretreatment outlet 420 (see FIG. 4). As the purified water flows into the pretreatment inlet 410 in the purified water circulation mode, water having a higher TDS concentration than the purified water remaining in the existing filtration zone 440a flows toward the passage hole 433, and when the purified water circulation mode continues for a predetermined amount of time or repeats a predetermined number of times, only pure purified water having a lowered TDS concentration by the reverse osmosis membrane 130 remains in the filtration zone 440a, the passage hole 433, and a passage flow path 422. In other words, the inner guide 430 is applied to the pretreatment filter 400 according to an embodiment of the present disclosure so that first-in, first-out may be effectively achieved, and when the purified water circulation mode continues for a predetermined amount of time or repeats a predetermined number of times, the pure purified water may be accommodated in the pretreatment filter 400 so that the flushing effect in the purified water flushing mode that may be performed later may be maximized.

Referring to FIG. 6, the purified water discharge mode is a mode in which the purified water is discharged externally. The controller 900 may control opening/closing of the plurality of valves so that, when in the purified water discharge mode, the raw water may flow into the raw water zone 110 via the pretreatment filter 400 and the purified water located in the purified water zone 120 may be discharged externally. In other words, the controller 900 may control the circulation valve 310 so that, when in the purified water discharge mode, the circulation flow path 210 may be closed, and the controller 900 may control the purified water discharge valve 320 so that the purified water discharge flow path 250 may be opened. Through the above-described control, the purified water may pass through the posttreatment filter 500 and be discharged externally through the discharge port 800. In addition, the controller 900 may control the daily use water discharge valve 330 so that, when in the purified water discharge mode, the daily use water discharge flow path 240 may be closed. Thus, the water for daily use may be discharged from the raw water zone 110 and may flow into the RO filter 100 through the return flow path 230 and the RO filter inflow flow path 220.

The controller 900 may control the plurality of valves based on the purified water circulation mode for a predetermined amount of time before controlling the plurality of valves based on the purified water discharge mode. In other words, after the purified water circulation mode is performed, the purified water discharge mode may be performed. When the purified water circulation mode is performed for the predetermined amount of time, the TDS concentration of the purified water located in the purified water zone 120 may be lowered compared to other cases, so that the user may be prevented from receiving the purified water having a high TDS concentration in the purified water discharge mode.

Meanwhile, the controller 900 may control the daily use water discharge valve 330 so that, when in the purified water discharge mode, when the amount in which the purified water located in the purified water zone 120 is continuously discharged through the discharge port 800, is greater than a reference discharge amount, the daily use water discharge flow path 240 may be opened. Thus, the water for daily use located in the raw water zone 110 may be discharged externally through the daily use water discharge flow path 240. In other words, when the amount in which the purified water is continuously discharged through the discharge port 800 is not greater than the reference discharge amount, the controller 900 may control the daily use water discharge valve 330 so that the daily use water discharge flow path 240 may be closed, and when the amount in which the purified water is continuously discharged through the discharge port 800 is greater than the reference discharge amount, the controller 900 may control the daily use water discharge valve 330 so that the daily use water discharge flow path 240 may be opened.

In the case of a water purifier using the RO filter 100, when the purified water greater than the reference discharge amount is continuously extracted, the RO filter 100 may be over-concentrated. Thus, when extraction of the reference discharge amount of the purified water is performed, a process of lowering the TDS concentration of the RO filter 100 by performing the flushing mode may be accompanied. On the other hand, the water purifier 1 according to an embodiment of the present disclosure may control the daily use water discharge valve 330 so that the daily use water discharge flow path 240 may be opened at a point of time where the amount in which the purified water is continuously discharged through the discharge port 800 is greater than the reference discharge amount, so that controlling may be performed and thus flushing may be performed simultaneously with purified water extraction, thereby solving the above-described problems.

When discharging of the water for daily use and extraction of the purified water are simultaneously performed, a sufficient pressure may not be provided to the reverse osmosis membrane 130 (the daily use water discharge flow path is opened so that the raw water zone communicates with the outside).

Thus, in the embodiment of the present disclosure, in the purified water discharge mode, when the purified water having an amount greater than the reference discharge amount is continuously extracted through the discharge port 800, the opening degree of the plurality of valves may be controlled so that the opening degree of the purified water discharge valve 320 may be greater than the opening degree of the daily use water discharge valve 330. In this case, the purified water discharge valve 320 and the daily use water discharge valve 330 may be valves of which the opening degree may be controlled. Through the above-described control, the pressure of the raw water zone 110 that communicates with the daily use water discharge flow path 240 may be higher than the pressure of the purified water zone 120 that communicates with the purified water discharge flow path 250 so that filtration by the reverse osmosis membrane 130 of the fluid located in the raw water zone 110 may be smoothly performed.

In another embodiment of the present disclosure, the purified water discharge valve 320 and the daily use water discharge valve 330 are valves that may be only opened or closed, and the size of a hole when the purified water discharge valve 320 is opened, may be formed to be greater than the size of the hole when the daily use water discharge valve 330 is opened. Similarly, even when all of the purified water discharge valve 320 and the daily use water discharge valve 330 are opened, the pressure of the raw water zone 110 that communicates with the daily use water discharge flow path 240 may be higher than the pressure of the purified water zone 120 that communicates with the purified water discharge flow path 250 so that filtration by the reverse osmosis membrane 130 of the fluid located in the raw water zone 110 may be smoothly performed.

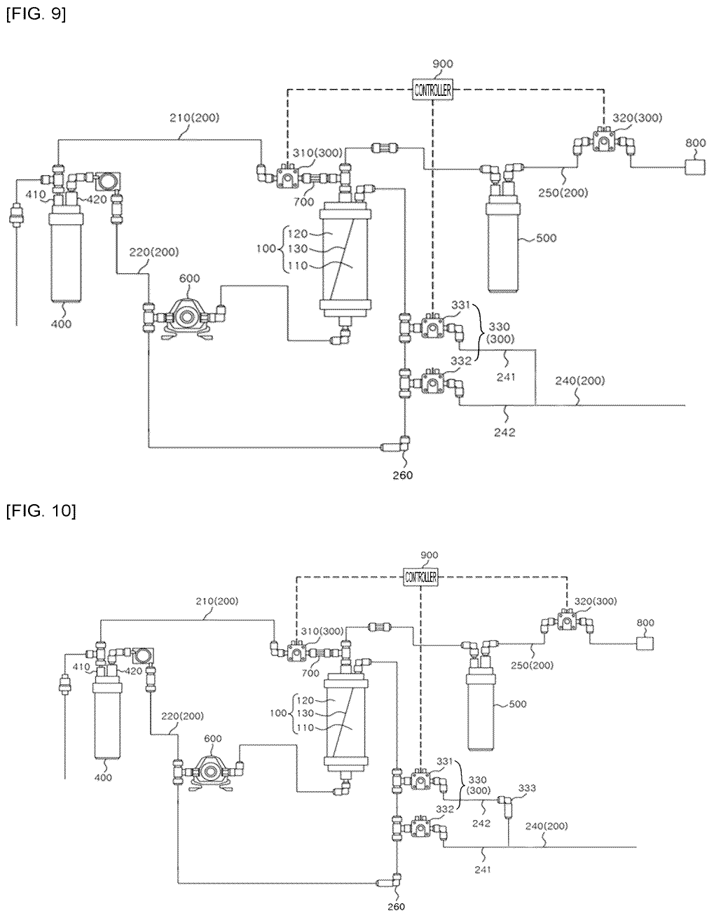

Referring to FIG. 9, the water purifier 1 according to another embodiment of the present disclosure may further include a first daily use water discharge flow path 241 and a second daily use water discharge flow path 242, which are respectively diverged from the return flow path 230 communicating with the raw water zone 110.

The first daily use water discharge flow path 241 and the second daily use water discharge flow path 242 may be joined at one point. In addition, a first daily use water discharge valve 331 may be installed on the first daily use water discharge flow path 241, and a second daily use water discharge valve 332 may be installed on the second daily use water discharge flow path 242.

The size of a hole when the first daily use water discharge valve 331 is opened, may be greater than the size of a hole when the second daily use water discharge valve 332 is opened. When the purified water having an amount greater than the reference discharge amount is discharged externally through the discharge port 800, the controller 900 may control the plurality of valves to close the first daily use water discharge valve 331 and to open the second daily use water discharge valve 332. The size of a hole when the second daily use water discharge valve 332 is opened, may be less than the size of a hole when the purified water discharge valve 320 is opened, and thus, even when all of the purified water discharge valve 320 and the second daily use water discharge valve 332 are opened, the pressure of the raw water zone 110 communicating with the second daily use water discharge valve 332 may be higher than the pressure of the purified water zone 120 communicating with the purified water discharge flow path 240, so that filtration of the fluid located in the raw water zone 110 by the reverse osmosis membrane 130 may be smoothly performed.

In addition, in the purified water flushing mode, the controller 900 may control opening/closing of the plurality of valves so that the first daily use water discharge valve 331 may be opened and the second daily use water discharge valve 332 may be closed. Thus, the purified water flowing into the raw water zone 110 may be more smoothly discharged externally.

Referring to FIG. 10, a third daily use water discharge valve 333 may be further installed at a downstream of the first daily use water discharge valve 331.

For example, the controller 900 may control opening/closing of the first and second daily use water discharge valves 331 and 332, and the opening degree of the third daily use water discharge valve 333 when the first and second daily use water discharge valves 331 and 332 are valves that may be only opened/closed and the third daily use water discharge valve 333 may be a valve of which opening degree may be controlled.

Specifically, the controller 900 may control opening/closing of the plurality of valves so that, when in the purified water discharge mode, when the amount of the purified water discharged externally through the discharge port 800 is greater than the reference discharge amount, the first daily use water discharge valve 331 may be opened and the second daily use water discharge valve 332 may be closed and the opening degree of the third daily use water discharge valve 333 may be less than the opening degree of the purified water discharge valve 320. Thus, even when all of the purified water discharge valve 320, the first daily use water discharge valve 331 and the third daily use water discharge valve 333 are opened, the pressure of the raw water zone 110 communicating with the third daily use water discharge valve 333 may be higher than the pressure of the purified water zone 120 communicating with the purified water discharge flow path 250, so that filtration of the fluid located in the raw water zone 110 by the reverse osmosis membrane 130 may be smoothly performed.

A flushing mode is a mode in which the reverse osmosis membrane 130 is cleaned with the raw water or purified water. A raw water flushing mode in which the reverse osmosis membrane 130 is cleaned with the raw water, may be performed after the purified water discharge mode. The controller 900 may control opening/closing of the plurality of valves so that, when in the raw water flushing mode, the raw water may flow into the raw water zone 110 via the pretreatment filter 400 and the water for daily use may be discharged externally from the raw water zone 110. Specifically, the controller 900 may control the circulation valve 310 so that, when in the raw water flushing mode, the circulation flow path 210 may be closed, and may control the purified water discharge valve 320 so that the purified water discharge flow path 250 may be closed, and may control the daily use water discharge valve 330 so that the daily use water discharge flow path 240 may be opened. Through the above-described control, the water for daily use may be discharged externally through the return flow path 230 and the daily use water discharge flow path 240 or may flow into the raw water zone 110 through the return flow path 230 and the RO filter inflow flow path 220.

The purified water flushing mode in which the reverse osmosis membrane 130 is cleaned with the purified water, may be performed when the purified water discharge mode and the purified water circulation mode are sequentially performed. The controller 900 may control opening/closing of the plurality of valves so that, when in the purified water flushing mode, the purified water accommodated in the pretreatment filter 400 may flow into the raw water zone 110 and the water for daily use in the raw water zone 110 may be discharged externally. Specifically, the controller 900 may control the circulation valve 310 so that, when in the purified water flushing mode, the circulation flow path 210 may be closed, may control the purified water discharge valve 320 so that the purified water discharge flow path 250 may be closed, and may control the daily use water discharge valve 330 so that the daily use water discharge flow path 240 may be opened. Through the above-described control, the purified water accommodated in the pretreatment filter 400 may flow into the raw water zone 110 through the RO filter inflow flow path 220. In addition, the water for daily use discharged from the raw water zone 110 may flow into the raw water zone 110 through the return flow path 230 and the RO filter inflow flow path 220 or may be discharged externally through the return flow path 230 and the daily use water discharge flow path 240.

The action and effect of the water purifier 1 based on the plurality of flow modes will be described as below.

The purified water 1 according to an embodiment of the present disclosure may perform a purified water circulation mode before and after the purified water discharge mode, respectively. In other words, the water purifier 1 may perform the purified water circulation mode, the purified water discharge mode, the raw water flushing mode, the purified water circulation mode, and the purified water flushing mode sequentially.

When in the purified water circulation mode, the water purifier 1 may circulate the purified water between the RO filter 100 and the pretreatment filter 400, thereby preventing the TDS concentration of the inside of the RO filter 100, in particular, the purified water zone 120 from being increased. In other words, because the purified water may circulate inside the water purifier 1 to flow into the purified water zone 120 from the raw water zone 110 in the purified water circulation mode, an increase in the concentration of the purified water zone 120 can be prevented.

In addition, because an inner guide is applied to the pretreatment filter to achieve the first-in, first-out effect, when the water purification circulation mode is performed, a certain amount of the purified water with a low TDS concentration may be stored in the pretreatment filter, so that the flushing effect in a flushing mode to be performed later is maximized and even when a separate water purification tank for performing flushing is not provided, flushing can be performed so that the water purifier can be miniaturized.

In addition, because the purified water is not discharged externally in the purified water circulation mode, the TDS concentration of the purified water located in the purified water zone 120 of the RO filter may be prevented from being increased and water can be prevented from being wasted.

In addition, the purified water circulation mode is performed for a certain amount of time before a purified water discharge mode so that the purified water may be circulated between the RO filter 100 and the pretreatment filter 400 a plurality of times so that the purified water having a low TDS concentration in the purified water discharge mode can be used to a user.

In addition, when in a raw water flushing mode and in a purified water flushing mode, a reverse osmosis membrane 130 may be cleaned and the water for daily use located in the raw water zone 110 can be discharged externally so that the TDS concentration of the RO filter 100 can be lowered.

In addition, the RO filter 100 can be cleaned with the purified water accommodated in the pretreatment filter 400 in the purified water flushing mode so that the TDS concentration of a fluid located in the raw water zone 110 of the RO filter 100 can be lowered.

In addition, a daily use water discharge flow path can be selectively opened or closed depending on whether the amount of the purified wafer continuously discharged through a discharge port in the purified water discharge mode is greater than a reference discharge amount or not, so that the overconcentration of the RO filter can be prevented.

As above, although the present invention has been described with reference to the embodiments illustrated in the drawings so that those skilled in the art can easily understand and reproduce the present invention, this is merely exemplary, and those skilled in the art will understand that various modifications and equivalent other embodiments are possible from the embodiments of the present invention. Thus, the protection scope of the present disclosure should be determined by the claims.

### EXPLANATION OF REFERENCE NUMERALS

1: water purifier
100: RO filter
110: raw water zone
120: purified water zone
130: reverse osmosis membrane
200: flow channel
210: circulation flow path
220: RO filter inflow flow path
230: return flow path
240: daily use water discharge flow path
250: purified water discharge flow path
260: resistance valve
300: valve unit
310: circulation valve
320: purified water discharge valve
330: daily use water discharge valve
400: pretreatment filter
400a: first end
400b: second end
410: pretreatment inlet
420: pretreatment outlet
430: inner guide
431: inner guide partition wall
432: passage flow path
440: filtering unit
440a: filtration zone
441: hollow
500: posttreatment filter
600: pump
700: circulation check valve
800: discharge port
900: controller

1. A water purifier comprising:
a reverse osmosis (RO) filter comprising a raw water zone into which raw water flows from an outside, a purified water zone for accommodating purified water generated by filtering at least a portion of the raw water located in the raw water zone, and a reverse osmosis membrane partitioning the raw water zone and the purified water zone;
a pretreatment filter configured to pretreat the raw water flowing into the RO filter and having a hollow through which the pretreated raw water passes;
a flow channel connected to the pretreatment filter and the RO filter and providing a passage on which the raw water and the purified water flow;
an inner guide comprising a cylindrical inner guide partition wall inserted into the hollow of the pretreatment filter and a passage hole formed through the inner guide partition wall and communicating with the hollow;
a plurality of valves connected to the pretreatment filter and the RO filter and selectively opened/closed to regulate flow of the raw water and the purified water; and
a controller configured to control opening/closing of the plurality of valves based on a plurality of flow modes.

2. The water purifier of claim 1, wherein the inner guide partition wall is arranged to cut off communication between a filtering unit of the pretreatment filter and the hollow, and has a passage flow path aligned with the hollow formed therein, and the passage hole communicates with the passage flow path, and a fluid flows into the inner guide through the passage hole.

3. The water purifier of claim 2, wherein the passage hole is arranged closer to a second end facing a first end in which a pretreatment inlet and a pretreatment outlet of the pretreatment filter are formed.

4. The water purifier of claim 2, wherein the fluid remaining in the pretreatment filter is discharged through the pretreatment outlet before the purified water flowing into the pretreatment filter.

5. The water purifier of claim 1, wherein the plurality of flow modes comprises a purified water circulation mode in which the purified water circulates between the pretreatment filter and the RO filter, and the controller controls opening/closing of the plurality of valves so that, when in the purified water circulation mode, the purified water discharged from the purified water zone flows into the pretreatment filter and the purified water that has passed through the pretreatment filter flows into the raw water zone.

6. The water purifier of claim 5, wherein the flow channel comprises a purified water circulation flow path connecting between the purified water zone and the pretreatment filter, and the plurality of valves further comprise a purified water circulation valve arranged on the purified water circulation flow path and configured to open/close the purified water circulation flow path, and the controller controls the purified water circulation valve so that, when in the purified water circulation mode, the purified water circulation flow path is opened.

7. The water purifier of claim 1, wherein the flow channel comprises: a RO filter inflow flow path connecting between a pretreatment outlet of the pretreatment filter and a raw water zone of the RO filter; and a return flow path connecting between the raw water zone and the RO filter inflow flow path.

8. The water purifier of claim 7, wherein the controller controls opening/closing of the plurality of valves so that, when in the purified water circulation mode, the daily use water discharged from the raw water zone flows into the raw water zone through the return flow path and the RO filter inflow flow path.

9. The water purifier of claim 1, wherein the plurality of flow modes further comprise a purified water discharge mode in which the purified water located in the purified water zone is discharged externally, and the controller controls opening/closing of the plurality of valves so that, when in the purified water discharge mode, the purified water located in the purified water zone is discharged externally.

10. The water purifier of claim 9, wherein the controller controls opening/closing of the plurality of valves according to the purified water circulation mode for a predetermined amount of time before the purified water discharge mode.

11. The water purifier of claim 9, wherein the flow channel comprises a purified water discharge flow path connecting between the purified water zone and a discharge port, and the plurality of valves comprise a purified water discharge valve arranged on the purified water discharge flow path and configured to open/close the purified water discharge flow path, and the controller controls opening/closing of the plurality of valves so that, when in the purified water circulation mode, the purified water discharge flow path is closed and when in the purified water discharge mode, the purified water discharge flow path is opened.

12. The water purifier of claim 9, wherein the plurality of flow modes further comprise a purified water flushing mode in which the reverse osmosis membrane is cleaned with the purified water accommodated in the pretreatment filter, and the controller controls opening/closing of the plurality of valves so that, when in the purified water flushing mode, the purified water accommodated in the pretreatment filter flows into the raw water zone and the water for daily use in the raw water zone is discharged externally.

13. The water purifier of claim 12, wherein the flow channel further comprises a daily use water discharge flow path on which the water for daily use in the raw water zone is discharged externally, and the plurality of valves further comprise a daily use water discharge valve arranged on the daily use water discharge flow path and configured to open/close the daily use water discharge flow path, and the controller controls opening/closing of the daily use water discharge valve so that the daily use water discharge flow path is closed in the purified water circulation mode and the purified water discharge mode and the daily use water discharge flow path is opened in the purified water flushing mode.

14. The water purifier of claim 12, wherein the controller controls opening/closing of the plurality of valves so that, in the purified water discharge mode, when an amount of the purified water located in the purified water zone and discharged externally through the discharge port is less than a reference discharge amount, the purified water discharge valve is opened and the daily use water discharge valve is closed, and when the amount of the purified water located in the purified water zone and discharged externally through the discharge port is greater than the reference discharge amount, the purified water discharge valve is opened and the daily use water discharge valve is opened.

15. The water purifier of claim 14, wherein the controller controls opening/closing of the plurality of valves so that, in the purified water discharge mode, when an amount of the purified water discharged externally through the discharge port is greater than a reference discharge amount, an opening degree of the purified water discharge valve is greater than an opening degree of the daily use water discharge valve.

16. The water purifier of claim 15, wherein a size of a hole when the purified water discharge valve is opened, is greater than a size of a hole when the daily use water discharge valve is opened.

17. The water purifier of claim 15, wherein the daily use water discharge flow path comprises:
a first daily use water discharge flow path; and
a second daily use water discharge flow path arranged in parallel to the first daily use water discharge flow path, and
the daily use water discharge valve comprises:
a first daily use water discharge valve arranged on the first daily use water discharge flow path; and
a second daily use water discharge valve arranged on the second daily use water discharge flow path.

18. The water purifier of claim 17, wherein a size of a hole when the first daily use water discharge valve is opened, is greater than a size of a hole when the second daily use water discharge valve is opened, and the controller controls opening/closing of the plurality of valves so that, in the purified water discharge mode, when an amount of the purified water discharged externally through the discharge port is greater than the reference discharge amount, the first daily use water discharge valve is closed, and the second daily use water discharge valve is opened.

19. The water purifier of claim 18, wherein the controller controls opening/closing of the plurality of valves so that, in the purified water flushing mode, the first daily use water discharge valve is opened and the second daily use water discharge valve is closed.

20. The water purifier of claim 17, further comprising a third daily use water discharge valve, which is arranged on the first daily use water discharge flow path to be located at a downstream of the first daily use water discharge valve and of which opening degree is capable of being regulated by the controller, and the controller controls opening/closing of the plurality of valves so that, in the purified water discharge mode, when an amount of the purified water discharged externally through the discharge port is greater than a reference discharge amount, the first daily use water discharge valve is opened, and the second daily use water discharge valve is closed, and the opening degree of the third daily use water discharge valve is less than the opening degree of the purified water discharge valve.
